(19) United States
(12) Patent Application Publication
(10) Pub. No.: US 2018/0152664 A1
(43) Pub. Date: May 31, 2018

(54) DISPLAY APPARATUS, CONTROL METHOD THEREFOR, AND STORAGE MEDIUM

(71) Applicant: CANON KABUSHIKI KAISHA, Tokyo (JP)

(72) Inventor: Hirofumi Urabe, Tokyo (JP)

(21) Appl. No.: 15/826,052

(22) Filed: Nov. 29, 2017

(30) Foreign Application Priority Data
Nov. 30, 2016 (JP) 2016-233255

(51) Int. Cl. H04N 7/01; H04N 7/18; H04N 7/10

(52) U.S. Cl. CPC H04N 7/0127; H04N 7/10; H04N 7/183

(57) ABSTRACT

A display apparatus includes a plurality of input units configured to receive a plurality of video signals generated from an original video signal, the original video signal having a first frame rate, and the plurality of video signals having a second frame rate lower than the first frame rate, an acquisition unit configured to acquire a sequence position of each of the video signals in the original video signal, based on information added to each of the video signals, a selection unit configured to select one or more target input units from the plurality of input units, based on the sequence position of the video signals, the number of selected target input units being smaller than the number of input units, and a display unit configured to display an image, based on the one or more video signals received by the one or more target input units.

### BACKGROUND OF THE INVENTION

### Field of the Invention

The present invention relates to a display apparatus for displaying an image based on a plurality of video signals input from a plurality of input terminals, a control method for the display apparatus, and a storage medium.

### Description of the Related Art

In recent years, there has been known output apparatuses capable of outputting a video signal having a high frame rate such as 120 Hz.

In some cases, a display apparatus cannot be driven at a driving frequency corresponding to a high frame rate of an input video signal. Japanese Patent Application Laid-Open No. 2014-236241 discusses a frame rate processing circuit. In a case where a frame frequency (a frame rate) of acquired video data is higher than a driving frequency of a display unit, the frame rate processing circuit performs down-converting for reducing the frame rate of the video data.

Meanwhile, there is a case where a plurality of low-frame-rate video signals is output using a plurality of output terminals. The low-frame-rate video signals are generated by periodically extracting a plurality of consecutive images of a high-frame-rate video signal. In this case, a display apparatus displays an image based on the original high-frame-rate video signal, by successively displaying images based on the low-frame-rate video signals.

### SUMMARY OF THE INVENTION

According to an aspect of the present invention, a display apparatus includes a plurality of input units configured to receive a plurality of video signals generated from an original video signal, the original video signal having a first frame rate, and the plurality of video signals having a second frame rate lower than the first frame rate, an acquisition unit configured to acquire a sequence position of each of the video signals in the original video signal, based on information added to each of the video signals, a selection unit configured to select one or more target input units from the plurality of input units, based on the sequence position of the video signals, the number of selected target input units being smaller than the number of input units, and a display unit configured to display an image, based on the one or more video signals received by the one or more target input units.

Further features of the present invention will become apparent from the following description of embodiments with reference to the attached drawings.

### BRIEF DESCRIPTION OF THE DRAWINGS

FIG. 1 is a diagram illustrating a configuration of a display system including a video output apparatus, a display apparatus, and a cable.

FIG. 2 is a functional block diagram illustrating functional blocks of the video output apparatus, the display apparatus, and the cable.

FIG. 3 is a schematic diagram illustrating a relationship between frames of each of video signals and frames of an original video signal in a case where a frame rate fp is 120 Hz.

FIG. 4 is a schematic diagram illustrating a relationship between frames of each of video signals and frames of an original video signal in a case where a frame rate fp is 60 Hz.

FIG. 5 is a schematic diagram illustrating a relationship between frames of each of video signals and frames of an original video signal in a case where a frame rate fp is 30 Hz.

FIG. 6 is a schematic diagram illustrating a relationship between frames of each of video signals and frames of a display signal.

FIG. 7 is a flowchart illustrating display processing performed by the display apparatus.

FIG. 8 is a schematic diagram illustrating a screen of a display unit displaying a warning based on a warning video signal.

FIG. 9 is a flowchart illustrating display signal generation processing.

FIG. 10 is a schematic diagram illustrating a screen of the display unit in a case where two-screen display is performed.

### DESCRIPTION OF THE EMBODIMENTS

Various embodiments, features, and aspects of the invention will be described in detail below with reference to the drawings.

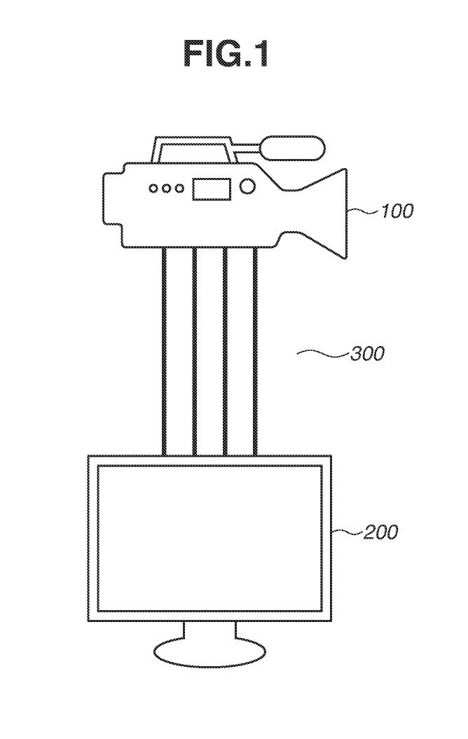

FIG. 1 is a diagram illustrating a configuration of a display system including a video output apparatus 100, a display apparatus 200, and a cable 300. The video output apparatus 100 outputs a video signal to the display apparatus 200. The cable 300 connects the video output apparatus 100 and the display apparatus 200.

The video output apparatus 100 generates a plurality of video signals having a frame rate lower than a frame rate of an original video signal, based on the original video signal, and outputs the generated video signals to the display apparatus 200 via the cable 300. For example, assume that the video output apparatus 100 is an imaging apparatus. Alternatively, the video output apparatus 100 may be a recording apparatus, such as a recorder, that includes a storage medium and outputs an original video signal stored in the storage medium. Further, the video output apparatus 100 may be a relay apparatus that outputs a plurality of video signals, based on an original video signal input from outside.

The display apparatus 200 displays an image, based on the plurality of input video signals. For example, assume that the display apparatus 200 is a liquid crystal display. Alternatively, the display apparatus 200 may be a projector that projects an image onto a screen.

The cable 300 connects the video output apparatus 100 and the display apparatus 200, and serves as an interface for transmitting video signals. The cable 300 has transmission paths respectively corresponding to output terminals of the video output apparatus 100 and input terminals of the display apparatus 200.

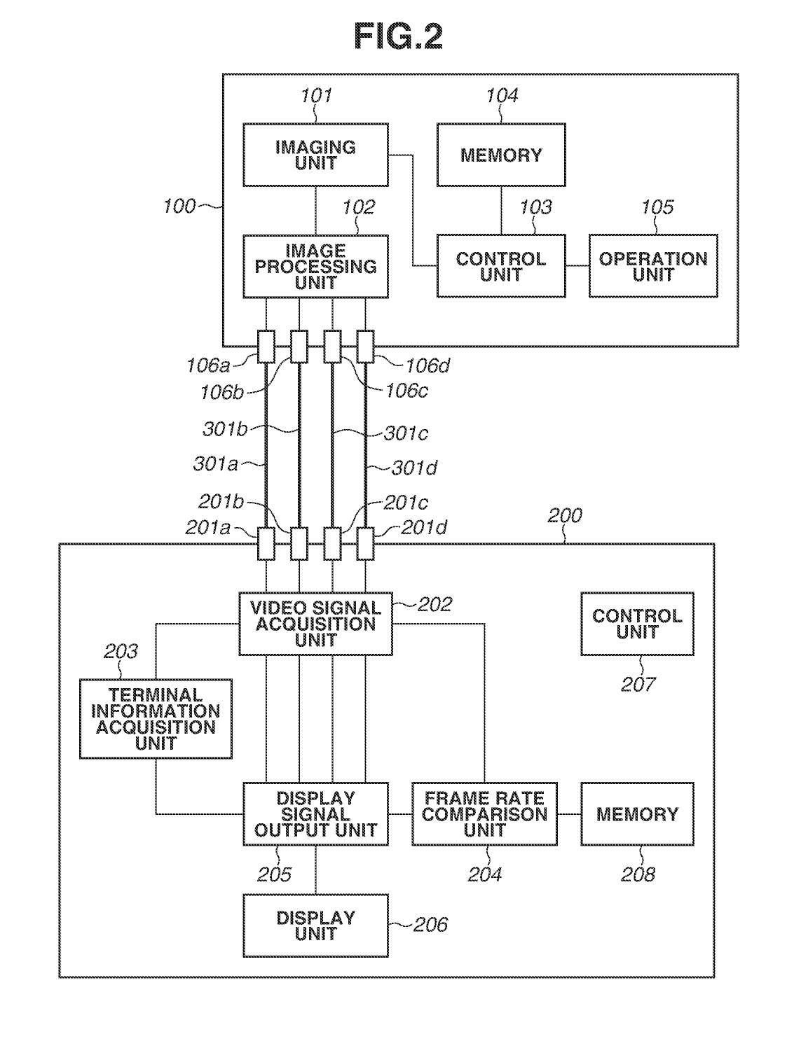

FIG. 2 is a functional block diagram illustrating functional blocks of the video output apparatus 100, the display apparatus 200, and the cable 300.

The video output apparatus 100 includes an imaging unit 101, an image processing unit 102, a control unit 103, a memory 104, an operation unit 105, and output terminals 106a to 106d.

The imaging unit 101 is an imaging means for outputting an original video signal obtained by capturing an image of an object. The imaging unit 101 includes an optical system, an imaging sensor, an imaging control circuit, and an output circuit. The optical system includes a lens. The imaging sensor detects light having passed through the optical system. The imaging control circuit controls the optical system and the imaging sensor. The output circuit outputs an original video signal, based on a signal output from the imaging sensor. The imaging unit 101 is similar to an imaging unit included in a conventional imaging apparatus such as a digital camera, and thus will not be described in detail.

The imaging unit 101 outputs an original video signal based on a signal output from the imaging sensor, to the image processing unit 102, based on setting information acquired from the control unit 103. The setting information includes a frame rate (fp) and a resolution for the original video signal. For example, assume that the original video signal is a signal having a progressive frame rate of 120 Hz for transmitting an image of such a resolution that the number of horizontal effective pixels is 3840 and the number of vertical effective lines is 2160 (3840×2160, 4K).

The image processing unit 102 is an image processing device for generating a plurality of video signals from the original video signal. The original video signal has a frame rate fp, and the plurality of video signals has a frame rate fs that is lower than the frame rate fp. The image processing unit 102 outputs the generated plurality of video signals to the output terminals 106a to 106d. More specifically, the image processing unit 102 outputs a video signal A having the frame rate fs to the output terminal 106a, and outputs a video signal B having the frame rate fs to the output terminal 106b. Further, the image processing unit 102 outputs a video signal C having the frame rate fs to the output terminal 106c, and outputs a video signal D having the frame rate fs to the output terminal 106d.

Herein, the frame rate fs of a video signal to be generated by the image processing unit 102 is decided according to a bandwidth allowing transmission by the output terminals 106a to 106d, input terminals 201a to 201d, and the cable 300. For example, if the output terminals 106a to 106d, the input terminals 201a to 201d, and the cable 300 are serial digital interface (SDI) compliant, and a transmission enabling frequency is 30 Hz, the image processing unit 102 accordingly outputs a video signal having the frame rate fs of 30 Hz. The frame rate fs of the video signal to be output by the image processing unit 102 can be freely set according to an instruction of a user. For example, assume that each of the video signals A to D is a signal having a progressive frame rate of 30 Hz for transmitting an image of a resolution of 3840×2160. The frame rate and the resolution of each of the original video signal and the video signals A to D can be freely set.

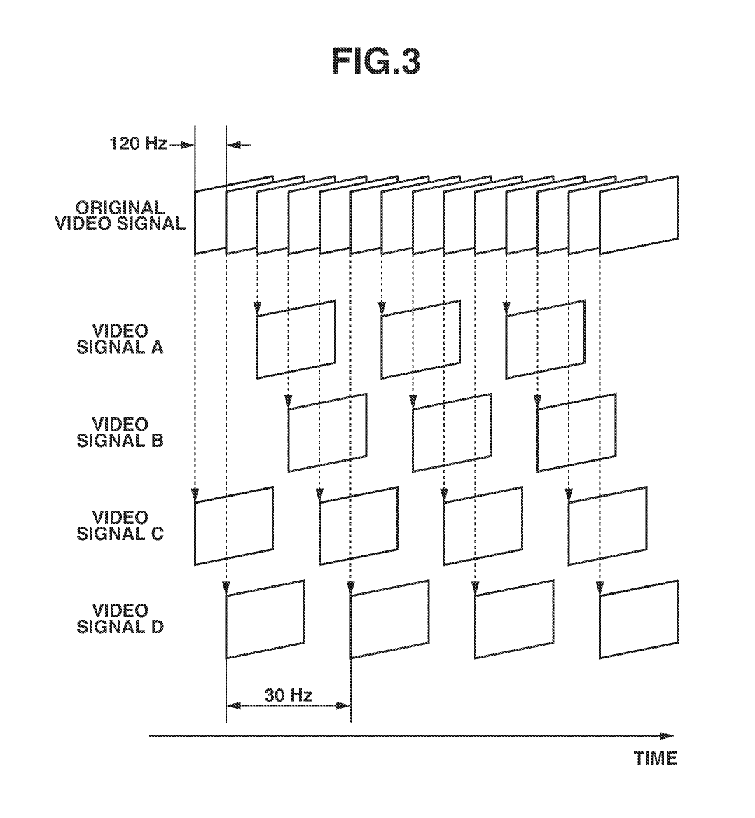

A relationship between frames of a video signal to be output from the image processing unit 102 to each of the output terminals and frames of an original video signal will be described with reference to FIGS. 3 to 5. In FIGS. 3 to 5, a horizontal axis indicates time. In FIGS. 3 to 5, each rectangle of each of the video signals indicates a frame. In FIGS. 3 to 5, arrows extend from frames of the original video signal to frames of each of the video signals, which indicates that frames connected by an arrow correspond to each other.

FIG. 3 is a schematic diagram illustrating a relationship between frames of each of video signals and frames of an original video signal, in a case where the frame rate fp is 120 Hz. The image processing unit 102 thins out the frames of the 120-Hz original video signal by using the frame rate fs, and thereby generates the video signals A to D. In other words, the image processing unit 102 generates the video signals A to D, by extracting frames of the original video signal in different phases of the frequency of the frame rate fs. The frames of the video signals correspond to the sequence of the frames of the original video signal, in a sequential order of a frame of the video signal A, a frame of the video signal B, a frame of the video signal C, and a frame of the video signal D.

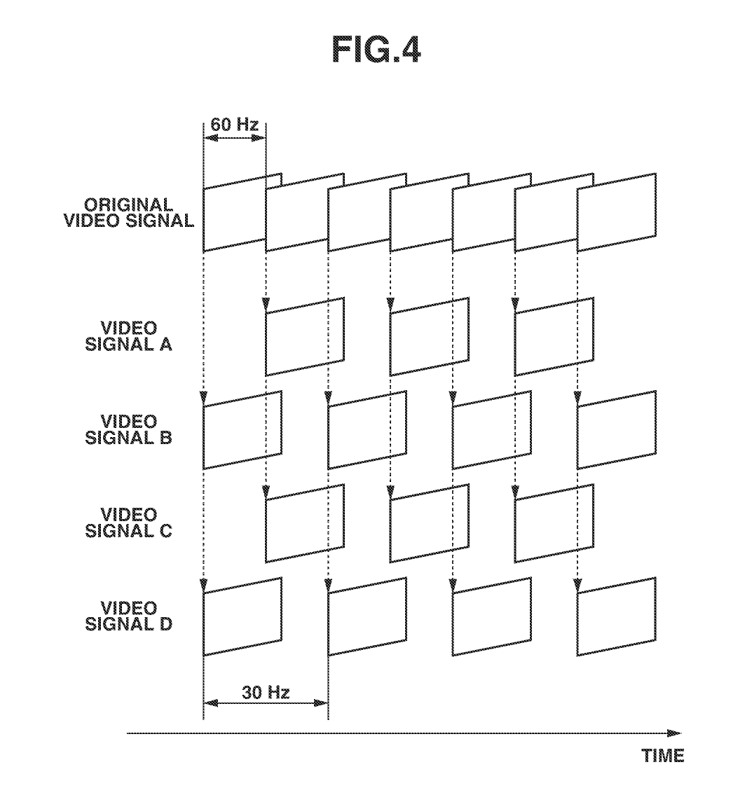

FIG. 4 is a schematic diagram illustrating a relationship between frames of each of video signals and frames of an original video signal, in a case where the frame rate fp is 60 Hz. The image processing unit 102 distributes the frames of the original video signal, to the video signals A and C, and the video signals B and D, alternately. Accordingly, the video signal A and the video signal C are substantially identical. Similarly, the video signal B and the video signal D are substantially identical.

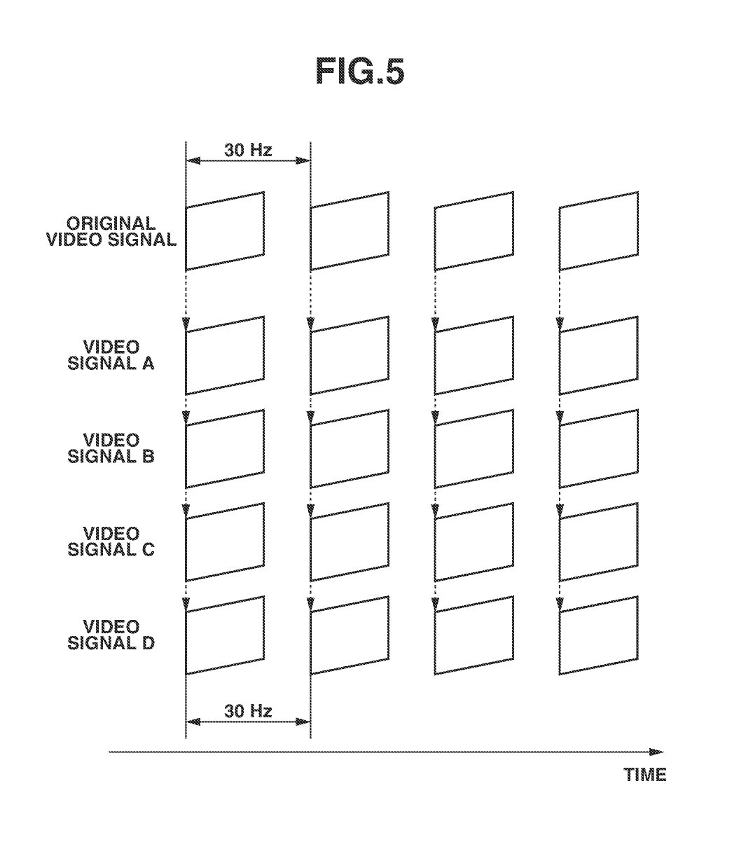

FIG. 5 is a schematic diagram illustrating a relationship between frames of each of video signals and frames of an original video signal, in a case where the frame rate fp is 30 Hz. The image processing unit 102 outputs a video signal similar to the original video signal, as each of the video signals A to D.

Further, the image processing unit 102 superimposes metadata, which indicates a sequence for a case of reproducing the original video signal from each of the video signals, on the generated video signals A to D. For example, when the video signals A to D are generated from the original video signal having the frame rate fp of 120 Hz, the image processing unit 102 superimposes information, which indicates that the frame of the video signal A precedes the frame of the video signal B and follows the frame of the video signal D, on the video signal A. The image processing unit 102 superimposes similar information on each of the video signals.

When the image processing unit 102 outputs a video signal from each of the output terminals, no actual video data is present during a blanking period. The image processing unit 102 may individually provide each of the output terminals with terminal information, which indicates the sequence position of the video signal to be output, as metadata, during the blanking period.

The control unit 103 is a calculation processing circuit for controlling the imaging unit 101 and the image processing unit 102, by executing a program stored in the memory 104. For example, the control unit 103 is a central processing unit (CPU). The control unit 103 sets the frame rate fp of the original video signal in the imaging unit 101, according to setting information indicating a frame rate input by the user via the operation unit 105, or setting information indicating a frame rate stored in the memory 104. The control unit 103 may set the resolution of the original video signal in the imaging unit 101, according to setting information indicating a resolution input by the user via the operation unit 105, or setting information indicating a resolution stored in the memory 104.

The memory 104 is a storage medium for storing a program and parameters to be used by the control unit 103 to control each function block. The memory 104 is a nonvolatile storage medium such as a hard disk, or a volatile storage medium such as a semiconductor memory.

The operation unit 105 is a user interface for the user to input setting information such as a frame rate and a resolution for an original video signal.

The output terminals 106a to 106d are each provided to output a video signal received from the image processing unit 102, to outside. For example, each of the output terminals 106a to 106d is an SDI-compliant connector.

The display apparatus 200 includes the input terminals 201a to 201d, a video signal acquisition unit 202, a terminal information acquisition unit 203, a frame rate comparison unit 204, a display signal output unit 205, a display unit 206, a control unit 207, and a memory 208.

The input terminals 201a to 201d are each provided to receive a video signal input from the video output apparatus 100 via the cable 300. For example, each of the input terminals 201a to 201d is an SDI-compliant connector.

The video signal acquisition unit 202 is a receiver capable of receiving a plurality of video signals. The video signal acquisition unit 202 outputs the video signals A to D to the display signal output unit 205. Further, the video signal acquisition unit 202 separates information indicating the sequence of the video signals for a case of reproducing the original video signal from each of the video signals. This information is superimposed on each of the video signals. The video signal acquisition unit 202 then outputs the information to the terminal information acquisition unit 203.

Furthermore, the video signal acquisition unit 202 acquires the frame rate fp of the original video signal that can be generated from the received plurality of video signals. The video signal acquisition unit 202 outputs the acquired frame rate fp to the frame rate comparison unit 204. For example, the video signal acquisition unit 202 acquires the frame rate fp, based on the information indicating the sequence and superimposed on the video signals A to D, and the frame rate of each of the video signals. In a case where the image processing unit 102 superimposes information indicating the frame rate fp on each of the video signals as metadata and then outputs this information, the video signal acquisition unit 202 can separate the information indicating the frame rate fp and output this information to the frame rate comparison unit 204.

Based on the acquired information indicating the sequence of the video signals for the case of reproducing the original video signal from each of the video signals, the terminal information acquisition unit 203 acquires the sequence position of each of the video signals with respect to the original video signal. For example, the terminal information acquisition unit 203 acquires information indicating that a frame of the video signal A precedes a frame of the video signal B and follows a frame of the video signal D, in the original video signal. The terminal information acquisition unit 203 is assumed to acquire similar information for each of the video signals. In a case of the video signals A to D generated from the original video signal having a frame rate fp of 120 Hz illustrated in FIG. 3, the terminal information acquisition unit 203 acquires information indicating that the video signals A to D are in the sequence of the video signal A, the video signal B, the video signal C, and the video signal D. The terminal information acquisition unit 203 then outputs the acquired information to the display signal output unit 205.

The frame rate comparison unit 204 is a determination circuit for determining whether the frame rate fp of the original video signal is higher than a predetermined value. For example, the frame rate comparison unit 204 compares a driving frequency fa of the display unit 206 and the frame rate fp of the original video signal, and thereby determines whether the display unit 206 can perform display based on the original video signal. For example, the driving frequency fa of the display unit 206 is 60 Hz.

In a case where the frame rate fp is higher than the driving frequency fa (in a case where the frame rate fp is higher than the predetermined value), the frame rate comparison unit 204 determines that the display unit 206 cannot perform display based on the original video signal. In a case where the frame rate fp is equal to or lower than the driving frequency fa (in a case where the frame rate fp is equal to or lower than the predetermined value), the frame rate comparison unit 204 determines that the display unit 206 can perform display based on the original video signal. The frame rate comparison unit 204 outputs a determination result to the display signal output unit 205.

According to the determination result of the frame rate comparison unit 204, the display signal output unit 205 sequentially outputs at least two or more video signals among the video signals A to D, to the display unit 206. Assume that the video signals to be output to the display unit 206 form a display signal. If it is determined that the display unit 206 can perform display based on the original video signal, the display signal output unit 205 sequentially outputs each frame of the video signals A to D, according to the sequence positions of the respective video signals acquired from the terminal information acquisition unit 203. In other words, the display signal output unit 205 selects the input terminals to which the display signals are to be input.

If it is determined that the display unit 206 cannot perform display based on the original video signal, the display signal output unit 205 outputs the display signal that allows display by the display unit 206 to the display unit 206. More specifically, the display signal output unit 205 selects the video signals to be output, in such a manner that frames spaced at substantially uniform intervals in the original video signal are sequentially output to the display unit 206 at a frame rate equal to or lower than a frame rate corresponding to the driving frequency fa. Based on the sequence positions of the respective video signals acquired from the terminal information acquisition unit 203, the display signal output unit 205 selects the video signals to be output among the video signals A to D. For example, in a case where the video signals A to D based on the original video signal having the frame rate fp of 120 Hz are input, and the driving frequency fa is 60 Hz, the display signal output unit 205 selects the video signal A and the video signal C. In this case, the display signal output unit 205 can also select the video signal B and the video signal D.

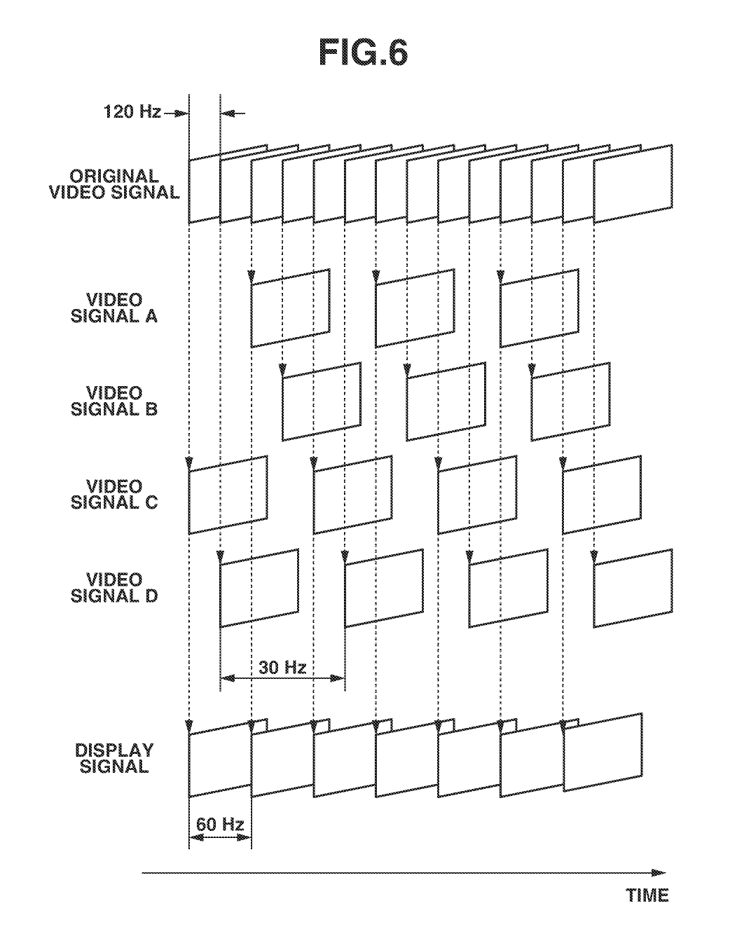

FIG. 6 is a schematic diagram illustrating a relationship between frames of each of input video signals and frames of a display signal. FIG. 6 illustrates the display signal in a case where the frame rate fp is higher than the driving frequency fa. For example, the frame rate fp of the original video signal is 120 Hz, the frame rate fs of the video signals A to D is 30 Hz, the driving frequency fa is 60 Hz, and the frame rate of the display signal is 60 Hz.

Based on the sequence position of each of the video signals acquired from the terminal information acquisition unit 203, the display signal output unit 205 selects the video signal A and the video signal C among the video signals A to D, and outputs the frames of the respective video signals, alternately. Consequently, frames spaced at substantially uniform intervals in the original video signal are sequentially output as the display signal.

Further, in a case where the video signals A to D generated from the original video signal having the frame rate fp of 60 Hz as illustrated in FIG. 4 are input, the display signal output unit 205 outputs the frame of the video signal A or the video signal C, and the frame of the video signal B or the video signal D, alternately.

Further, in a case where the video signals A to D generated from the original video signal having the frame rate fp of 30 Hz as illustrated in FIG. 5 are input, the display signal output unit 205 outputs any video signal among the video signals A to D, as the display signal.

The display unit 206 displays an image on a screen, based on the video signals output from the display signal output unit 205. For example, the display unit 206 is a liquid crystal display having a liquid crystal panel and a backlight. The display unit 206 may be a projector for displaying an image by projecting the image onto a screen.

The display unit 206 performs display by changing images at the driving frequency fa set beforehand. In a case where the display unit 206 is a liquid crystal display, the display unit 206 controls the transmittance of liquid crystal elements of the liquid crystal panel at the driving frequency fa, thereby changing images. Information indicating the driving frequency fa is stored beforehand in the memory 208. For example, the driving frequency fa is a frequency corresponding to an upper limit of a driving frequency for allowing operation of the display unit 206. The driving frequency fa can be freely set by the user.

The control unit 207 is a calculation processing circuit for controlling each function block of the display apparatus 200, by executing a program stored in the memory 208. For example, the control unit 207 is a CPU. The control unit 207 can control display of the display unit 206, including a display layout to be displayed by the display unit 206.

The memory 208 is a storage medium for storing a program and parameters to be used by the control unit 207 to control each function block. The memory 208 is a nonvolatile storage medium such as a hard disk, or a volatile storage medium such as a semiconductor memory.

For example, the video signal acquisition unit 202, the terminal information acquisition unit 203, the frame rate comparison unit 204, and the display signal output unit 205 are configured of different electronic circuits, and controlled by the control unit 207 to operate. The control unit 207 can also implement the function of one or more functional blocks among the video signal acquisition unit 202, the terminal information acquisition unit 203, the frame rate comparison unit 204, and the display signal output unit 205, by executing a program.

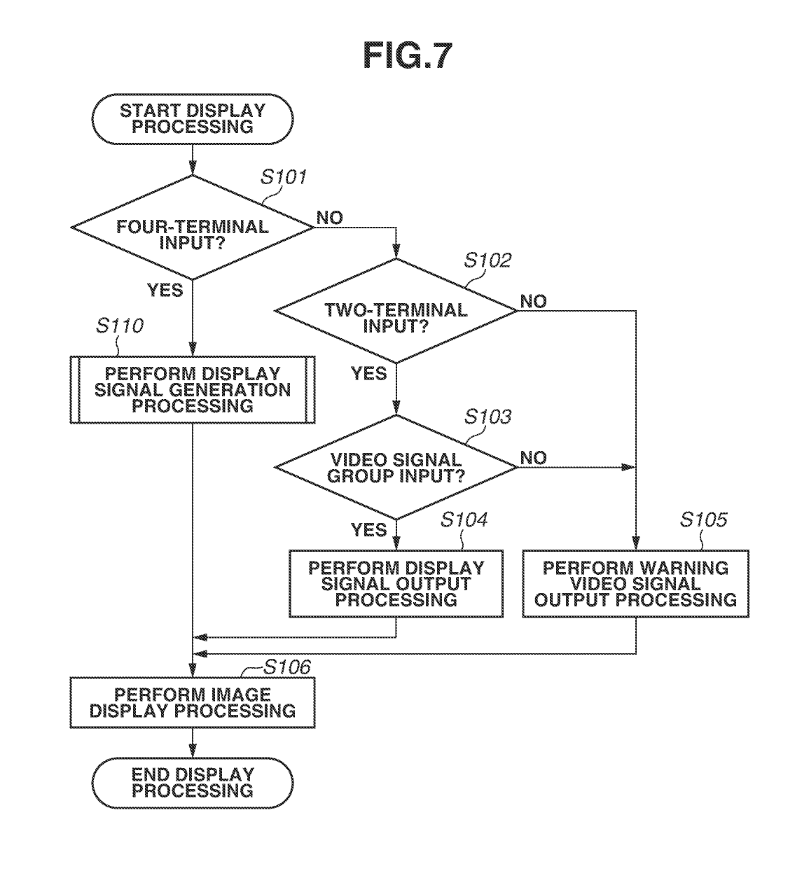

FIG. 7 is a flowchart illustrating display processing of the display apparatus 200. To be described below is a case where the video output apparatus 100 generates the video signals A to D having the frame rate fs of 30 Hz from the original video signal having the frame rate fp of 120 Hz, and outputs the generated video signals A to D to the display apparatus 200.

The display processing starts when a video signal is input to each of the input terminals, or when the display apparatus 200 is instructed by the user to display an image.

In step S101, the video signal acquisition unit 202 determines whether the different video signals A to D are input to the four input terminal, i.e., whether there is four-terminal input. For example, the video signal acquisition unit 202 compares frames of the respective video signals A to D, and thereby determines whether there is four-terminal input. The video signal acquisition unit 202 can also determine whether there is four-terminal input, based on information indicating the sequence of the video signals for a case of reproducing the original video signal. The information is superimposed on each of the video signals.

In a case where an input terminal to which no video signal is input is present among the four input terminals, the video signal acquisition unit 202 determines that there is no four-terminal input.

In a case where the frame rate fp of the original video signal is 30 Hz, the video signals A to D are all identical. In this case, the video signal acquisition unit 202 determines that the video signals are input to the four input terminals, and that the frame rate fp of the original video signal is 30 Hz, based on image-capture information provided in a blanking period. Thus, the video signal acquisition unit 202 determines that substantially there is one-terminal input (NO in step S101). In this case, the processing proceeds to step S102.

In step S110, each function block of the display apparatus 200 executes display signal generation processing. In this processing, video signals to be output to the display unit 206 are selected from the video signals A to D, and the selected video signals are output to the display unit 206 as the display signal. This processing will be described in detail below. The processing then proceeds to step S106.

In step S102, the control unit 207 acquires information of each of the video signals from the video signal acquisition unit 202, and determines whether two or more video signals among the video signals into which the original video signal is divided are input (two-terminal input). If two or more video signals among the video signals into which the original video signal is divided are input (YES in step S102), the processing proceeds to step S103. If two or more video signals among the video signals into which the original video signal is divided are not input (NO in step S102), the processing proceeds to step S105.

In step S103, the control unit 207 acquires the sequence position of each of the video signals in the original video signal input from the terminal information acquisition unit 203, and thereby determines whether a plurality of video signals (a video signal group) formed of frames spaced at substantially uniform intervals in the original video signal is input. More specifically, the control unit 207 determines whether a video signal group formed of the video signal A and the video signal C, or a video signal group formed of the video signal B and the video signal D is input. If it is determined that a plurality of video signals formed of frames spaced at substantially uniform intervals in the original video signal is input (YES in step S103), the processing proceeds to step S104. If it is determined that a plurality of video signals formed of frames spaced at substantially uniform intervals in the original video signal is not input (NO in step S103), the processing proceeds to step S105.

In step S104, the display signal output unit 205 sequentially outputs the video signals of the video signal group. For example, in a case where the video signal A and the video signal C are selected, the display signal output unit 205 outputs a frame of the video signal A and a frame of the video signal C, alternately. The processing then proceeds to step S106.

In step S105, the control unit 207 outputs a warning video signal to the display unit 206. The warning video signal forms an image for warning that only part of the entire video is displayed and thus appropriate monitoring cannot be performed. For example, the warning video signal is a video signal for displaying an on-screen display (OSD) image representing a video of the input terminal. The warning video signal is superimposed on a video signal generated by sequentially outputting frames of an input video signal at the frame rate fp.

For example, assume that a video signal is input only to each of the input terminal 201a and the input terminal 201b, among the input terminals 201a to 201d. In a case where a frame of the video signal A and a frame of the video signal B are alternately output, frames at nonuniform intervals among the frames of the original video signal are sequentially arranged in the display signal. For example, if a frame of the video signal A is assumed be a frame 1 of the original video signal, the display signal has frames 1, 2, 5, 6, 9, 10 and so on of the original video signal. In this case, since the intervals between the frames of the display signal are not uniform, temporal continuity of display is impaired (jerky) and an appropriate video cannot be displayed.

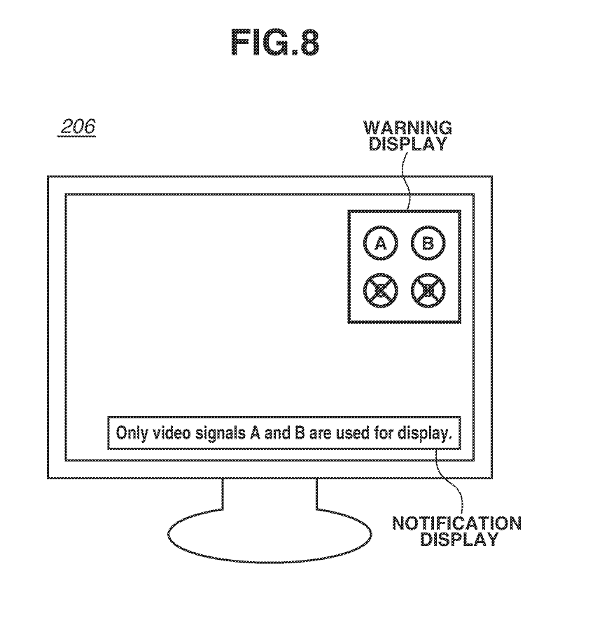

FIG. 8 is a schematic diagram illustrating a screen of the display unit 206 displaying a warning based on the warning video signal. Referring to FIG. 8, the screen displays, for example, an image based on the display signal formed of the video signal A and the video signal B. In addition, warning display for displaying a layout and a connection status of the input terminals is superimposed on the displayed image based on the display signal, at an upper right part of the screen. Displayed on a lower right part of the screen is a notification image (a graphical user interface (GUI)) indicating which video signals form the currently displayed image. In other words, the displayed notification image (GUI) indicates which input terminals among the plurality of input terminals have received the video signals.

Providing the warning display prompts the user to verify the connection status, or an error in setting of the original video signal. This can reduce connection failures and video verification errors during image capturing.

In step S106, the display unit 206 displays an image on the screen, based on the display signal output from the display signal output unit 205.

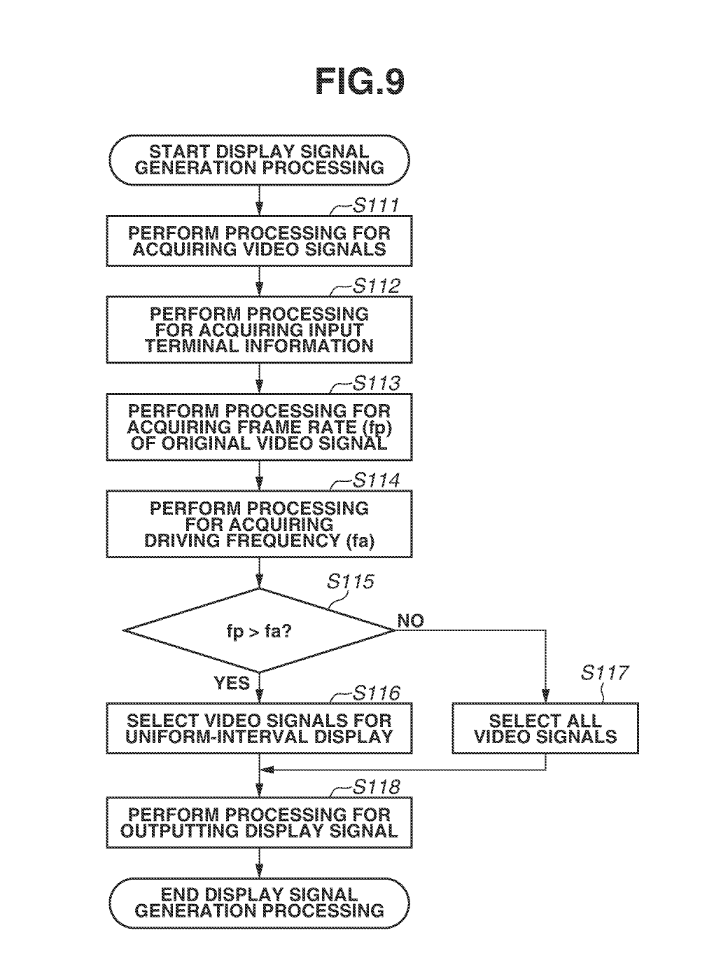

FIG. 9 is a flowchart illustrating the display signal generation processing in step S110.

In step S111, the video signal acquisition unit 202 executes processing for acquiring the input video signals A to D from the input terminals 201a to 201d. Further, the video signal acquisition unit 202 separates metadata superimposed on the video signals A to D, and outputs the metadata to the terminal information acquisition unit 203.

Furthermore, the video signal acquisition unit 202 executes processing for acquiring the frame rate fp of the original video signal that can be generated using the video signals A to D. The video signal acquisition unit 202 outputs the frame rate fp to the frame rate comparison unit 204. The processing then proceeds to step S112.

In step S112, the terminal information acquisition unit 203 executes processing for acquiring information indicating the sequence of the video signals for a case of reproducing the original video signal from each of the video signals, by analyzing the received metadata. Based on the acquired information, the terminal information acquisition unit 203 acquires the sequence position of each of the video signals with respect to the original video signal, and outputs the acquired sequence position to the display signal output unit 205. The processing then proceeds to step S113.

In step S113, the frame rate comparison unit 204 executes processing for acquiring the frame rate fp from the video signal acquisition unit 202. The processing then proceeds to step S114.

In step S114, the frame rate comparison unit 204 executes processing for acquiring the driving frequency fa of the display unit 206, from the memory 208. The processing then proceeds to step S115.

In step S115, the frame rate comparison unit 204 determines whether the frame rate fp is higher than the driving frequency fa. If it is determined that the frame rate fp is higher than the driving frequency fa (YES in step S115), the processing proceeds to step S116. If it is determined that the frame rate fp is equal to or lower than the driving frequency fa (NO in step S115), the processing proceeds to step S117.

In step S116, based on the sequence position acquired by the terminal information acquisition unit 203, the display signal output unit 205 executes processing for selecting video signals to be output, in such a manner that frames spaced at substantially uniform intervals in the original video signal are output to the display unit 206. For example, the display signal output unit 205 selects the video signal A and the video signal C. The processing then proceeds to step S118.

In step S117, the display signal output unit 205 executes processing for selecting all the video signals, as video signals to be output to the display unit 206. The processing then proceeds to step S118.

In step S118, the display signal output unit 205 executes processing for outputting the selected video signals to the display unit 206 as the display signal, by changing the selected video signals according to the sequence position acquired by the terminal information acquisition unit 203. This ends the display signal generation processing to be executed in a case where it is determined that there is four-terminal input.

In a case where a plurality of video signals based on the original video signal that has a frame rate higher than a frame rate that allows display by the display apparatus 200 is input, executing the above-described processing makes it possible to generate video signals that allows display by the display apparatus 200 and to perform display based on the generated video signals without generating the original video signal. In addition, appropriate video signals are selected based on information indicating the sequence positions of the respective video signals, thereby suppressing causing a feeling of strangeness about a displayed image to a user.

In the present embodiment, the output terminals 106a to 106d, the cable 300, and the input terminals 201a to 201d are each described as an SDI-compliant interface, but this is not limitative. Interfaces complying with standards such as HDMI (registered trademark) and DisplayPort (DP) can also be used.

It is also possible to perform two-screen display, in a case where an image is displayed based on a plurality of video signals input based on the original video signal having a high frame rate not allowing display by the display unit 206. For example, the control unit 207 controls a layout in such a manner that an image is displayed in the two-screen display, by controlling the display signal output unit 205 and the display unit 206.

In this case, based on the sequence positions of the respective video signals acquired by the terminal information acquisition unit 203, the display signal output unit 205 acquires a combination of video signals formed of frames spaced at substantially uniform intervals in the original video signal. For example, in a case where the video signals A to D based on the original video signal illustrated in FIG. 4 are input, the display signal output unit 205 acquires the combination of the video signal A and the video signal C, and the combination of the video signal B and the video signal D.

The display signal output unit 205 outputs the video signals to the display unit 206 as the display signal, for each combination of the video signals. For example, the display signal output unit 205 alternately outputs a frame of the video signal A and a frame of the video signal C, as a display signal a. Further, the display signal output unit 205 alternately outputs a frame of the video signal B and a frame of the video signal D, as a display signal b.

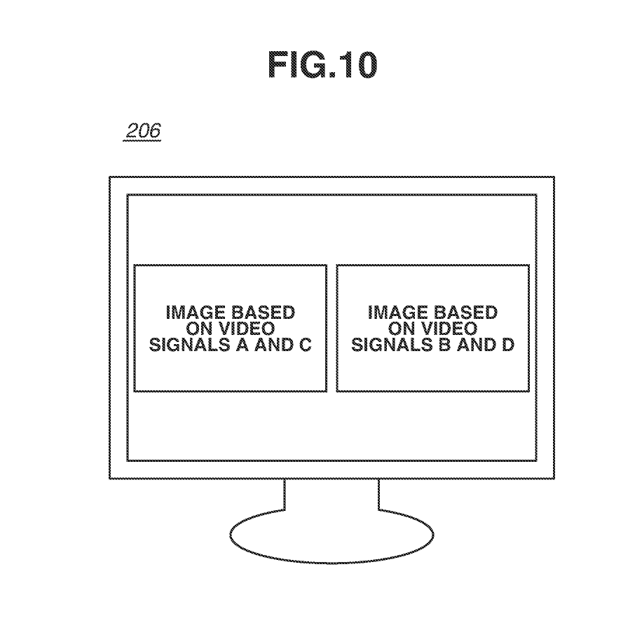

The display unit 206 displays an image based on the display signal a and an image based on the display signal b, in different display areas. The display unit 206 updates the display at the driving frequency fa, by synchronizing the display signal a and the display signal b. FIG. 10 is a schematic diagram illustrating a screen of the display unit 206 in a case where the two-screen display is performed. For example, the display unit 206 displays an image based on the display signal a (the video signals A and C), on the right side of the screen. Further, the display unit 206 displays an image based on the display signal b (the video signals B and D), on the left side of the screen.

As described above, multiscreen display is performed by generating a plurality of display signals that allows display by a display apparatus, from a plurality of low-frame-rate video signals generated from a high-frame-rate original video signal. This enables the user to verify the plurality of video signals.

The display apparatus 200 may have an operation unit for changing between one-screen display and two-screen display according to an instruction of the user, in a case where the frame rate fp of the original video signal is higher than the driving frequency fa of the display apparatus 200.

The frame rate fp of the original video signal is not limited to the frame rate described above. For example, the frame rate fp of the original video signal may be 240 Hz, and the frame rate fs may be 60 Hz. In this case, the video output apparatus 100 generates four video signals having the frame rate fs from the original video signal, and outputs the generated four video signals to the display apparatus 200 via the output terminals 106a to 106d. In a case where the driving frequency (frame rate) fa allowing display by the display apparatus 200 is 60 Hz, the display apparatus 200 selects one of the input terminals 201a to 201d. Further, in a case where the driving frequency (frame rate) fa allowing display by the display apparatus 200 is 120 Hz, the display apparatus 200 selects two input terminals having a temporally uniform interval relationship in the original video signal, from the input terminals 201a to 201d. The display apparatus 200 displays an image based on the video signals input to the selected input terminals.

Moreover, the resolution of the original video signal is not limited to 4K. Video signals formed of frames of an 8K or more resolution may be adopted.

Selecting video signals to be used for display by the display signal output unit 205 is substantially equivalent to selecting input terminals to receive the video signals to be used for display. In a case where the frame rate fp of the original video signal is higher than the driving frequency fa allowing display, the display signal output unit 205 generates a display signal having a frame rate equal to or lower than the driving frequency fa, by using selected video signals (video signals input to selected input terminals). In other words, the display signal output unit 205 does not use unselected video signals (video signals input to unselected input terminals), for generation of the display signal.

The display unit 206 can also display a GUI indicating input terminals to receive video signals to be used for display. Accordingly, in a case where not all of a plurality of input terminals is used for display, the user can use an output, which is connected to an unselected input terminal, of the video output apparatus 100, for other purpose.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to embodiments, it is to be understood that the invention is not limited to the disclosed embodiments.

This application claims the benefit of Japanese Patent Application No. 2016-233255, filed Nov. 30, 2016, which is hereby incorporated by reference herein in its entirety.

What is claimed is:

1. A display apparatus comprising:
a plurality of input units configured to receive a plurality of video signals generated from an original video signal, the original video signal having a first frame rate, and the plurality of video signals having a second frame rate lower than the first frame rate;
an acquisition unit configured to acquire a sequence position of each of the video signals in the original video signal, based on information added to each of the video signals;
a selection unit configured to select one or more target input units from the plurality of input units, based on the sequence position of the video signals, the number of selected target input units being smaller than the number of input units; and
a display unit configured to display an image, based on the one or more video signals received by the one or more target input units.

2. The display apparatus according to claim 1, wherein the display unit displays an image without using a video signal received by an input unit that is not a target input unit.

3. The display apparatus according to claim 1,
wherein the acquisition unit is arranged to acquire the first frame rate, based on information added to at least one video signal among the plurality of video signals, and
wherein, in a case where the first frame rate is higher than a predetermined frame rate, the selection unit is arranged to select the one or more target input units from the plurality of input units based on the sequence position.

4. The display apparatus according to claim 3, wherein, in the case where the first frame rate is higher than the predetermined frame rate, the selection unit is arranged to select the one or more target input units based on the sequence position so that the image is displayed based on frames spaced at uniform intervals in the original video signal.

5. The display apparatus according to claim 3, wherein, in a case where the first frame rate is equal to or lower than the predetermined frame rate, the display unit is arranged to display an image, based on the original video signal generated from the plurality of video signals.

6. The display apparatus according to claim 3, wherein the predetermined frame rate is at least one of a frame rate at which the display unit displays the image and a frame rate corresponding to an upper limit of a driving frequency at which the display unit can operate.

7. The display apparatus according to claim 1, wherein the plurality of video signals are video signals obtained by thinning out frames of the original video signal in different phases of the second frame rate.

8. The display apparatus according to claim 1, further comprising a display control unit configured to control a display layout of the display unit,
wherein, in a case where the display control unit is arranged to cause the display unit to display two images based on a first display signal and a second display signal, an output unit is arranged to output a first video signal and a third video signal alternately as the first display signal, and output a second video signal and a fourth video signal alternately as the second display signal.

9. The display apparatus according to claim 1, wherein the resolution of the original video signal is 3840 horizontal effective pixels or more and 2160 vertical effective lines has a resolution of 4K or more.

10. The display apparatus according to claim 1, wherein the first frame rate of the original video signal is 120 Hz or more.

11. The display apparatus according to claim 1, wherein the display unit is arranged to display a graphical user interface for displaying information indicating the one or more target input units.

12. The display apparatus according to claim 1, further comprising a display control unit for controlling a display layout of the display unit,
wherein the display control unit is arranged to cause the display unit to display an image based on a first display signal generated based on the one or more video signals received by the one or more target input units, and an image based on a second display signal generated based on the one or more video signals received by one or more other input units that are not the one or more target input units, among the plurality of input units.

13. A method for controlling a display apparatus, the display apparatus including a plurality of input units configured to receive a plurality of video signals generated from an original video signal, the original video signal having a first frame rate, and the plurality of video signals having a second frame rate lower than the first frame rate, the method comprising:
acquiring a sequence position of each of the video signals in the original video signal, based on information added to each of the video signals;
selecting one or more target input units from the plurality of input units, based on the sequence position of the video signals, the number of selected target input units being smaller than a number of the plurality of input units; and
displaying an image, based on the one or more video signals received by the one or more target input units.

14. The method according to claim 13, wherein the image is displayed without using a video signal received by an input unit that is not a target input unit.

15. The method according to claim 13,
wherein the first frame rate is acquired, based on information added to at least one video signal among the plurality of video signals, and
wherein, in a case where the first frame rate is higher than a predetermined frame rate, the one or more target input units are selected from the plurality of input units based on the sequence position.

16. The method according to claim 15, wherein, in the case where the first frame rate is higher than the predetermined frame rate, the one or more target input units are selected based on the sequence position so that the image is displayed based on frames spaced at uniform intervals in the original video signal.

17. The method according to claim 15, wherein, in a case where the first frame rate is equal to or lower than the predetermined frame rate, the image is displayed, based on the original video signal generated from the plurality of video signals.

18. The method according to claim 15, wherein the predetermined frame rate is at least one of a frame rate at which the display apparatus displays the image and a frame rate corresponding to an upper limit of a driving frequency at which the display apparatus can operate.

19. The method according to claim 13, wherein the image is displayed together with a graphical user interface indicating the one or more target input units.

20. A non-transitory computer-readable storage medium storing a program configured to cause a computer to execute a method for controlling a display apparatus, the display apparatus including a plurality of input units configured to receive a plurality of video signals generated from an original video signal, the original video signal having a first frame rate, and the plurality of video signals having a second frame rate lower than the first frame rate, the method comprising:
acquiring a sequence position of each of the video signals in the original video signal, based on information added to each of the video signals;
selecting one or more target input units from the plurality of input units, based on the sequence position of the video signals, the number of selected target input units being smaller than a number of the plurality of input units; and
displaying an image, based on the one or more video signals received by the one or more target input units.
